(19) United States
(12) Patent Application Publication
(10) Pub. No.: US 2024/0420863 A1
(43) Pub. Date: Dec. 19, 2024

(54) MICROSTRUCTURED TRANSMISSION GRATING FOR X-RADIATION AND CORRESPONDING MANUFACTURING METHOD

(71) Applicant: Fraunhofer-Gesellschaft zur Förderung der angewandten Forschung e.V., München (DE)

(72) Inventors: Ole BEHRMANN, Itzehoe (DE); Thomas LISEC, Itzehoe (DE); Mani-Teja BODDULURI, Itzehoe (DE); Björn GOJDKA, Itzehoe (DE)

(73) Assignee: Fraunhofer-Gesellschaft zur Förderung der angewandten Forschung e.V., München (DE)

(21) Appl. No.: 18/743,112

(22) Filed: Jun. 14, 2024

(30) Foreign Application Priority Data
Jun. 14, 2023 (DE) 102023205555.4

(51) Int. Cl. G21K 1/10

(52) U.S. Cl. CPC G21K 1/10

(57) ABSTRACT

Embodiments according to the present invention include a method for manufacturing a micostructured transmission grating for X-radiation, the method comprising: providing a substrate and creating a grating structure by means of structuring a plurality of periodically arranged cavities in a first main side of the substrate, wherein individual ridges of substrate material remain between each of the cavities, and filling the cavities with a plurality of particles present in the form of loose, dry powder. In this regard, the substrate has a lower absorption of X-radiation than the dry particle powder.

### CROSS-REFERENCE TO RELATED APPLICATIONS

This application claims priority from German Patent Application No. 102023205555.4, which was filed on Jun. 14, 2023, and is incorporated herein in its entirety by reference.

Embodiments according to the present invention include microstructured transmission gratings for X-radiation, wherein the grating structure of the transmission grating comprises, inter alia, a plurality of particles with a high X-ray absorption, and associated manufacturing methods.

### BACKGROUND OF THE INVENTION

Reliable and economical manufacturing of transmission gratings for X-ray light constitutes an existing technical problem. Analogously to transmission gratings for visible light, transmission gratings for X-ray light consist, e.g., of a plurality of alternating radiolucent and opaque lines. The particular challenge is manufacturing the lines that are opaque for (i.e. absorbing) X-rays, as these must be made from a suitable material. For the technical application of these gratings, e.g., for clinical dark field radiography, large grating surfaces of up to 1600 cm² are necessary, which poses great challenges for corresponding manufacturing processes.

Conventional approaches include LIGA (lithography, electroplating, and molding) techniques, wherein, after developing a photoresist by means of an electroplating method, a metallic seed layer is applied, on which an X-ray absorbing material is subsequently electroplated. The chip surface that can be manufactured using LIGA, however, is limited to only a few square centimeters with low throughput. Furthermore, LIGA involves a synchrotron for exposing the photoresist. This leads to very high process costs. In order to prevent a deformation of the photoresist structures, they furthermore must be periodically connected using ridges, which increases the expenditure in manufacturing.

Further approaches include manufacturing X-ray transmission gratings in silicon substrates using etching processes followed by electroplating of the X-ray absorber. Such approaches, however, involve elaborate processing in the clean room after the etching.

Moreover, only few electroplating processes are available for depositing X-ray absorbing materials, so that in both previously discussed approaches, only a limited material selection may be used. Additionally, these approaches cause very high process times for electroplating and carry a high risk of process deviations.

Further conventional approaches include manufacturing X-ray transmission gratings by introducing metal particles in a solvent (suspension) into micro-cavities. In the first step, grating structures are structured into silicon substrates by means of an etching process. In the second step, the metal particles solved in the wet suspension are applied to the grating structures, and the substrate is placed into an (ultra) centrifuge. The wet metal particles are then urged into the grating gap by means of centrifugation. In the next step, the solvent is vaporized, and the particles are mechanically fixated by means of a binding agent added to the suspension. Finally, the surface of the grating structures is mechanically cleansed of metal particles resting on the structure.

FIGS. 8A-8C show an example for such a process flow for manufacturing an X-ray transmission grating by means of centrifugation of a wet metal particle suspension. FIG. 8A shows grating portions before (left) and after (right) a cleaning process. FIG. 8B shows a corresponding grating after the cleaning process, and FIG. 8C shows an enlarged section of the view of FIG. 8B.

As can be seen in FIG. 8C, undesired voids between metal particles form in this manufacturing method, which can be explained by the inclusion of gas bubbles in the suspension. Furthermore, a lateral inhomogeneous filling of the grating structures may occur due to variations in the particle suspension. Moreover, such an approach causes high mechanical loads of the substrates during the centrifugation as well as high obstacles for process automation.

### SUMMARY

According to an embodiment, a method for manufacturing a micostructured transmission grating for X-radiation may have the steps of: providing a substrate and creating a grating structure by means of structuring a plurality of periodically arranged cavities in a first main side of the substrate, wherein individual ridges of substrate material remain between each of the cavities; filling the cavities with particles in the form of loose, dry powder; wherein the substrate comprises a lower absorption of X-radiation than the particles located in the cavities.

According to another embodiment, a microstructured transmission grating for X-radiation may have: a substrate with a grating structure, the grating structure comprising multiple alternating first and second grating portions; wherein the first grating portions comprise a plurality of particles present in the form of loose, dry powder and/or in the form of particles consolidated by means of a coating; and wherein the first grating portions comprise a higher absorption of X-radiation than the second grating portions in order to thus form the microstructured transmission grating for the X-radiation.

Embodiments according to the present invention include a method for manufacturing a microstructured transmission grating for X-radiation, wherein the method comprises the following steps, which are, in principle, also executable in an order different from the one given here: providing a substrate and creating a grating structure by means of structuring a plurality of periodically arranged cavities in a first main side of the substrate, wherein individual ridges of substrate material remain between each of the cavities, and filling the cavities with a plurality of particles present in the form of loose, dry powder. Here, the substrate comprises a lower absorption of X-radiation than the dry particle powder.

Furthermore, embodiments according to the present invention include a microstructured transmission grating for X-radiation. In this regard, the transmission grating comprises a substrate having a grating structure, wherein the grating structure comprises multiple alternating first and second grating portions. Furthermore, the first grating portions comprise a plurality of particles present in the form of loose, dry powder and/or in the form of particles consolidated by means of a coating. Moreover, the first grating portions comprise a higher absorption of X-radiation than the second grating portions, in order to thus form the microstructured transmission grating for the X-radiation.

Optionally, the substrate further comprises a plurality of periodically arranged cavities. In which the particles of the respective first grating portions are at least partially arranged.

Embodiments according to the present invention are based on the core idea of manufacturing the X-ray absorbing material of the transmission grating by means of a loose, dry powder. Here, it was found that a plurality of materials suitable for X-ray absorption can be provided in the form of powder, and that corresponding powders may further be processed for manufacturing grating structures with low effort compared to conventional techniques. As explained above, the powder may, e.g., be filled into cavities of a substrate in order to thus form X-ray absorbing grating lines of the transmission grating. The powder may therefore serve as X-ray absorbing absorber powder and form first grating portions of the transmission grating. Substrate ridges remaining between the cavities may form second grating portions which are arranged so as to alternate with the first grating sections, so that a transmission grating with multiple alternating first and second grating portions arises as a result.

Using the X-ray absorbing material in the form of a lose, dry powder, allows for a particularly simple, quick, and reliable filling of the cavities. This means that, compared to conventional technology, a slow electroplating process is not necessary. Thus, the technological effort for manufacturing may also be kept to a minimum as only the loose, dry powder may be filled into the cavities. Thus, for example, “thick” X-ray absorbing grating lines can be manufactured with low effort as a corresponding thickness (e.g., of at least 100 μm) may be primarily dependent only on the manufacture of the cavity (into which the powder is “simply” filled) but not on an depositing process.

Thus, an inventive transmission grating may be manufactured within a short time but also with high reliability. Here, the manufacturing precision regarding a geometry of the grating depends, e.g., primarily only on the manufacture of the cavities into which the powder is filled. There is no dependence on, e.g., galvanic process parameters or binding agents. Additionally, an expensive and elaborate centrifugation is not necessary. In particular, this allows keeping a mechanic load on the substrate and the X-ray absorbing material low.

Additionally, it was found that, by using loose, dry powder, it is also possible to achieve a high degree of homogeneity of the X-ray absorbing structures, i.e., for example, the first grating portions. The powder may optionally be additionally compacted in the cavities in order to thus prevent any possible gas inclusions.

At this point, it should be noted that, optionally, both the substrate ridges may be partially removed and/or replaced by means of another material, and the loose, dry powder may be consolidated and/or partially consolidated by means of a coating to form porous bodies.

The powder may, for example, be present in the form of a granular material, or in the form of a pulverized material. Corresponding powders may therefore, in other words, include a large amount of small particles or be composed of such an amount. The particles may comprise an average or maximum particle size of less than 50 μm, or of less than 25 μm, or of less than 15 μm, or of less than 5 μm, or of less than 1 μm.

According to embodiments of the present invention, the method further comprises a consolidation of the loose, dry powder present within the cavities. In that regard, the particles present in the form of powder may be consolidated completely or only partially. This (partial) consolidation may be performed by applying a coating process, wherein a coating material used therein penetrates voids between individual particles and thus fixedly joins the particles to one another. This results in consolidated porous structural bodies, which may comprise high strength. This means, that, according to the invention, at least a part of the plurality of particles within the cavities are provided in the form of consolidated porous bodies having a higher X-radiation absorption compared to the substrate.

In other words, the method therefore optionally comprises an at least partial consolidation of the loose, dry powder present in the cavities by applying a coating process, wherein the powder consolidated within a cavity forms, in each case, a consolidated porous body in the respective cavity, and wherein the respective consolidated porous bodies comprise a higher X-radiation absorption compared to the substrate.

According to embodiments of the present invention, the at least partially consolidated particles may thus be present both in the form of not yet consolidated loose, dry powder and in the form of particles consolidated by means of the coating to form porous bodies.

The unconsolidated loose, dry powder may, in each case, be arranged so as to be enclosed between the consolidated particles and the substrate in the cavities.

For example, a type of “plug” may be created by means of the consolidated particles in the respective cavities in order to prevent the loose, dry powder present in the respective cavity from falling out. The solid porous bodies formed by the consolidated particles may therefore be present, in particular, at an end of the respective cavity facing away from the substrate. This may result from the coating material used in the coating process penetrating from the top downwards into the cavity and therefore coating the particles present in the cavities from the top downwards. The coating process may be controlled such that only a (top) part of the particles is coated and consolidated, or that all particles are completely coated and consolidated. Accordingly, in the case of a partial consolidation, the loose, dry powder that remained uncoated in a cavity may correspondingly be present at a (bottom) end of the cavity facing the substrate. Optionally, the coating material may also serve to attach a thus created solid porous body to an inner wall of the cavity. The inner wall of the cavity may be made of substrate material, formed of, e.g., ridges left behind during the structuring of the cavities, or also be made of a different material, e.g., a filling material or a grouting material which removed or partially removed substrate ridges were replaced by.

In an inventive transmission grating, the particles may therefore be present partially or completely in the form of particles consolidated by means of the coating to form porous bodies, wherein these consolidated porous bodies may each form the first grating portions.

By means of a complete consolidated, a stiffness and/or a mechanical stability of the transmission grating may be increased. Furthermore, the first grating structure may be fastened in a robust manner in the cavity by means of the coating as the coating may fasten the individual grating lines, i.e., for example, the ridges including the consolidated particles, in the cavity down to a floor structure of the cavity.

According to embodiments of the present invention, the coating process may be performed using a liquid polymer. Alternatively or additionally, the coating process may include a deposition of organic or inorganic substances from a gaseous phase, e.g., by means of a chemical vapor deposition (CVD) or, e.g., by means of an atomic layer deposition (ALD). Particularly an atomic layer deposition allows penetrating the interspaces between the particles by means of the coating and mechanically and reliably joining the particles at their points of contact.

According to embodiments of the present invention, the method further includes applying a cap layer to the grating structure or to the first main side of the substrate so as to enclose the plurality of particles in the cavities. According to embodiments, the cap layer may therefore be arranged on the grating structure in order to enclose the particles in the first grating portions.

The cap layer may be applied as an alternative or in addition to the above described consolidation of the loose, dry powder. The cap layer may cap, or cover, loose, dry powder present in the cavities or in the first grating portions, so that the powder is enclosed in the respective cavity and is therefore consolidated. The cap layer may, itself, contain a plurality of particles present in the form of loose, dry powder and/or in the form of consolidated or agglomerated particles in order to enclose the particles below in the cavity. In this case, a porous body arranged at an end facing away from the substrate, together with the cap layer, may serve as a “double lid” for the loose, dry powder. For the sake of completeness, it should be mentioned here that applying a cap layer is also possible in the case of completely consolidated or agglomerated powder in a respective cavity.

Applying the cap layer may include at least one of the following process steps: applying a mechanically stable film, e.g., a polymer film or a metal film, such as a thin aluminum film, applying a polymer layer (e.g., a liquid polymer layer and optionally subsequent curing of the polymer layer), and/or applying organic or inorganic substances deposited from the gaseous phase, e.g. by means of chemical and/or physical vapor deposition or, e.g., by means of atomic layer deposition.

When arranging the cap layer on the grating structure, the loose, dry powder present in the cavities may also be at least partially consolidated by means of the cap layer material or the cap layer coating itself.

For an orderly function of the transmission grating, it may be significant that the surface of the substrate is largely free of particles of the absorbing material, particularly in the region of the substrate ridges between the X-ray absorbing grating lines. Accumulations of absorbing particles may locally affect the absorption behavior of the transmission grating negatively, and thus cause image defects.

A sacrificial layer may be used in the manufacture of the transmission grating to remove particles from the substrate surface. For example, a photoresist or a silicon layer may serve as a sacrificial layer. The sacrificial layer may be applied and structured before creating the cavities, so that the surfaces of the substrate, including the substrate ridges, are covered, completely or partially, by the sacrificial layer before introducing the particles. After creating the absorbing grating lines, the sacrificial layer may be removed selectively to all other present materials by use of a suitable etching process. In this case, particles present on the sacrificial layers may be detached or removed completely or partially, so that a clean substrate surface remains, which is largely or completely free of particles.

Alternatively or additionally, the surface of the transmission grating may be smoothed and/or polished after applying a cap layer in order to remove absorbing particles from the substrate surface outside the X-ray absorbing grating lines.

According to embodiments of the present invention, the method further includes backthinning a second main side of the substrate opposite the first main side. This way, absorbing particles may be removed easily, even from the other side of the substrate. Moreover, mechanical properties, such as a stiffness of the transmission grating, and/or optical properties, such as regarding a beam path or a length of a respective beam path in the substrate material, may be adjusted (e.g., in case of a rear side radiation). By manufacturing the transmission grating by means of filling in particles and the optional coating, which may be performed, e.g., at different temperatures, the substrate may comprise only slight internal stresses or other stress induced weak points, so that it is possible to weaken the substrate structurally to adjust properties of the transmission grating.

According to embodiments of the present invention, the method further includes at least partially removing one or multiple ridges made of substrate material. The ridges may be configured starting from the first main side and/or from a second main side of the substrate opposite the first main side. This allows adjusting mechanical and/or optical properties of the transmission grating. For example, the removal of ridge material between the first grating portions may result in the stiffness of the transmission grating being decreased, so that the transmission grating can be bent more easily.

Regions in which the ridges made of substrate material are removed completely or partially may be filled completely or partially with a filler, wherein the filler comprises a lower absorption of X-radiation than the respectively adjacent loose or (partially) consolidated particles. By means of a corresponding filler, which, for that matter, may also be an environmental fluid such as air, an X-ray absorption deviating from the substrate material may therefore be set in order to create the transmission grating with alternating grating portions of different radiation absorptions. Alternatively or additionally, the filler may be used to adapt mechanical properties. For example, a filler may be used which allows for an increased bendability of the transmission grating while simultaneously serving as a spacer between the individual portions (first grating portions) containing particles, so that the spacers form flexible second grating portions, each of which is arranged between the first grating portions. This means that the second grating portions may be formed at least partially by the filler.

For example, due to a removal of ridges of the substrate, a transmission grating may thus optionally no longer comprise any cavities in the substrate material, according to embodiments. In particular, the cavities created during the manufacturing process may no longer be present insofar that they are filled with the particles. In this case, new cavities may be formed in the regions in which ridges made of substrate material have been removed but not filled by means of filler. The particles may also correspondingly be enclosed at least partially in cavities formed by means of filler and substrate.

In some embodiments, the first grating portions may partially project out of the cavities in the substrate material. In this case, a corresponding first grating portion would therefore be arranged, e.g., only partially in a cavity.

According to embodiments of the present invention, a respective cavity comprises an aspect ratio (width/depth) of at least 1:9 or at least 1:5. Furthermore, a grating period of the grating structure may optionally be 50 μm. For example, a distance between two successive first grating portions and/or two successive second grating portions may be less than 50 μm with respect to a predefined direction of arrival of the X-radiation. In this case, the particles may particularly comprise, for example, average or maximum particles sizes of less than 50 μm, or of less than 25 μm, or of less than 15 μm, or of less than 5 μm, or of less than 1 μm.

According to embodiments of the present invention, the particles may comprise at least tungsten and/or bismuth and/or gold. In this regard, embodiments of the invention allow processing particularly tungsten efficiently, which has not been possible in this form with conventional methods. Using the inventive method, tungsten may be processed in the form of loose, dry powder with low technological effort so as to create the grating portions described herein, which comprise a very high absorption degree for X-radiation.

According to embodiments of the present invention, the substrate may comprise or be made of at least one of the following materials: silicon, glass, sapphire, ceramic, or polymers. Embodiments therefore allow using common substrate materials and therefore offer good flexibility.

According to embodiments of the present invention, the first grating portions may comprise a particle distribution free of imperfections, wherein imperfections are voids which are several times larger than an average pore size of the porous bodies.

### BRIEF DESCRIPTION OF THE DRAWINGS

Embodiments of the present invention will be detailed subsequently referring to the appended drawings, in which:

FIG. 1 shows a schematic view of a microstructured transmission grating for X-radiation according to embodiments of the present invention;

FIGS. 2A-2B show a schematic representation of an example of a filling process of a substrate having cavities with loose powder according to embodiments of the present invention;

FIGS. 3A-3B show schematic side views of transmission gratings with an optional cap layer and optionally consolidated particles according to embodiments of the present invention;

FIGS. 4A-4B show schematic side views of transmission gratings with an optionally thinned substrate and optionally partially removed substrate ridges according to embodiments of the present invention;

FIG. 5 shows a transmission grating according to embodiments of the present invention;

FIGS. 6A-6H show views of transmission gratings and associated intermediate products in a manufacturing method according to embodiments of the present invention;

FIGS. 7A-7T show views of further optional configurations of transmission gratings according to embodiments of the present invention; and

FIGS. 8A-8C show an example for X-ray transmission gratings manufactured by means of centrifugation of a metal particle suspension.

### DETAILED DESCRIPTION OF THE INVENTION

Before embodiments of the present invention are subsequently described in detail on the basis of the drawings, it is to be noted that identical or functionally identical elements, objects and/or structures or elements, objects and/or structures having the same effect are provided in the different figures with the same reference numerals so that the description of these elements illustrated in different embodiments is mutually exchangeable, or may mutually applicable.

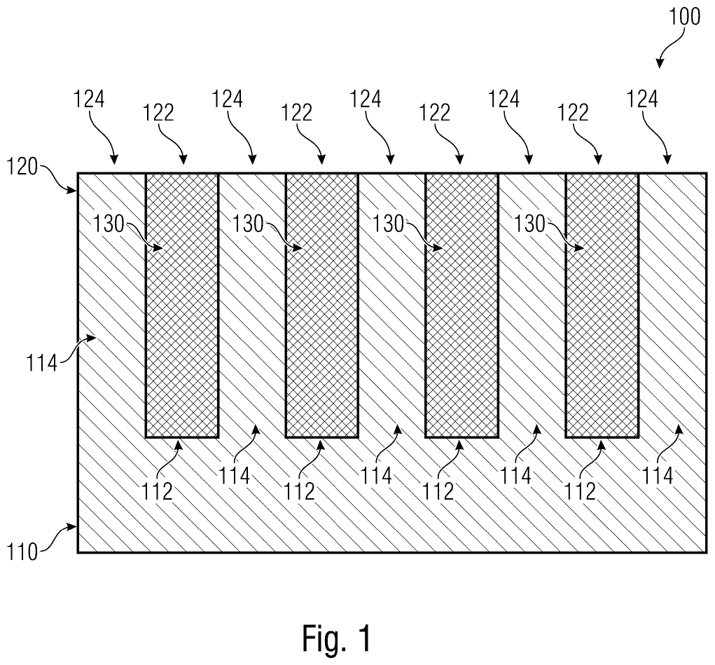

FIG. 1 shows a schematic view of a microstructured transmission grating 100 for X-radiation according to embodiments of the present invention.

The transmission grating 100 comprises a substrate 110 having a grating structure 120. The grating structure 120 comprises multiple alternating first and second grating portions 122, 124 arranged next to one another. The first grating portions contain or comprise a plurality of particles 130 (only schematically adumbrated here), which may be present in the form of loose, dry powder and/or in the form of particles consolidated by means of a coating. Furthermore, the first grating portions 122 comprise a higher absorption of X-radiation than the second grating portions 124 in order to thus form the microstructured transmission grating 100 with different radiation absorption coefficients for X-radiation.

In other words, the first and second grating portions 122, 124 are arranged in an alternating manner to thus form lines of the transmission grating 100 that are more or less absorbing. The second grating portions 124 may comprise ridges 114 of substrate material or be formed of such ridges 114. As will be explained in more detail below, such ridges 114 may also be removed completely or partially, and they may be replaced completely or partially by another material, e.g., by a filler or a grouting material.

Furthermore, a manufacturing method according to embodiments is explained below with reference to FIG. 1. The method comprises providing the substrate 110 and creating a grating structure 120 in or on the substrate 110. The grating structure 120 may be created by a plurality of periodically arranged cavities 112 being structured into a first main side of the substrate, wherein individual ridges 114 of substrate material remain between each of the cavities 112.

The cavities 112 may then be those regions which are limited by the substrate 110 with successive ridges 114. Furthermore, the method comprises filling the cavities 112 with a plurality of particles 130 in the form of loose, dry powder. To that end, the cavities 112 may be filled at least partially, advantageously completely, with the loose, dry powder.

According to the invention, the particles 130 comprise a higher absorption for X-radiation that the substrate 110. Thus, a transmission grating 120 is created which alternatingly comprises first grating portions 122 and second grating portions 124, wherein the first grating portions 122 comprise a higher absorption of X-radiation than the second grating portions 124. The first grating portions 122 may, in this case, be formed by means of the previously mentioned particles 130, which are first introduced into the cavities 112 in the form of loose, dry powder, and may subsequently optionally be consolidated and/or partially consolidated. The second grating portions 124 may be formed of the ridges 114 of substrate material remaining between the cavities 112.

Both the cavities 112 filled with the particles 130 and the loose and/or (partially) consolidated particles 130, present in the cavities 112, themselves may, in the context of the present disclosure, be referred to as first grating portions 122.

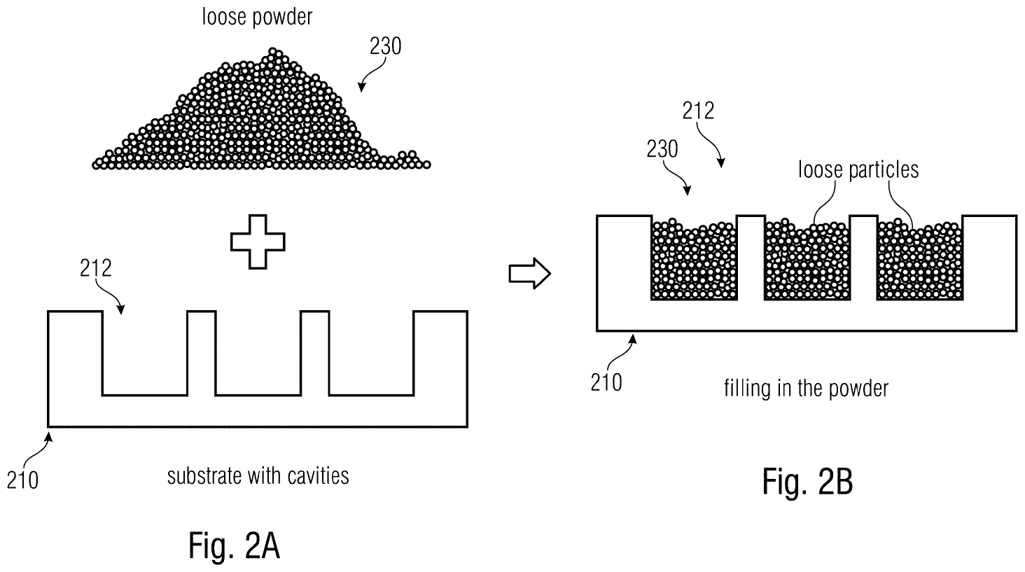

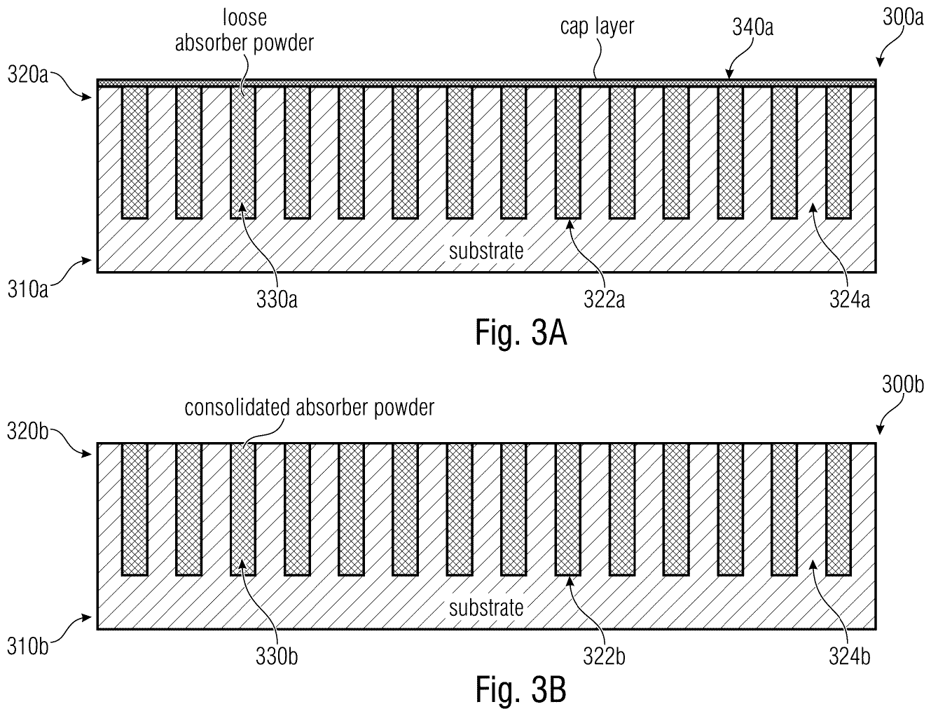

In the following, reference is made to FIGS. 2A, 2B and 3A, 3B.

FIGS. 2A and 2B show a schematic representation of an example of a filling process of cavities present in a substrate with loose, dry powder according to embodiments of the present invention. FIG. 2A shows a substrate 210 with cavities 212 as well as a plurality of particles 230 in the form of a loose, dry powder. FIG. 2B shows the substrate 210 with particles 230 filled in, wherein the particle powder 230 largely fills the cavities 212 completely.

FIGS. 3A and 3B show schematic side views of inventive transmission gratings 300a, 330b with an optional cap layer 340a, or optionally consolidated particles.

FIG. 3A shows a transmission grating 300a comprising a substrate 310a and a grating structure 320a. The grating structure 320a comprises first grating portions 322a formed by a plurality of particles, which, in this case, are present in the form of loose powder 330a, e.g., absorber powder. The grating structure 320a comprises second grating portions 324a arranged between the first grating portions 322a, which may, for example, be configured in the form of ridges made of substrate material. The transmission grating 300a may optionally comprise a cap layer 340a. The cap layer 340a may be configured, for example, in the form of a polymer film and/or in the form of a polymer, e.g., in the form of a curable epoxy resin. Alternatively or additionally, the cap layer 340a may be formed by means of organic or inorganic substances deposited from the gaseous phase, e.g., using a CVD process.

FIG. 3B shows an alternative embodiment of an inventive transmission grating 300b with a substrate 310b and a grating structure 320b. Here, the first grating portions 322b are configured in the form of at least partially, or advantageously completely, consolidated particles 330b. The particles 330b first present in powder form may, for example, be coated using an atomic layer deposition (ALD) and be (partially) consolidated thereby. The (partially) consolidated particles 330b of the originally loose, dry powder 330a may form a plurality of solid porous bodies, which may form the first grating portions 322b and therefore the X-radiation absorbing lines of the transmission grating 300b. Here, as well, the second grating portions 324b may be formed in the form of ridges made of substrate material.

FIG. 3B thus shows an embodiment, wherein a previously loose absorber powder is converted into solid porous structural bodies with high X-radiation absorption by the powder particles being enveloped by means of a suitable coating method (e.g., ALD). In this process, the particles 330a are mechanically joined at their points of contact by means of the coating. For example, liquid polymers or organic or inorganic substances deposited from the gaseous phase (e.g., using the ALD method) may be used for mechanically joining or consolidating the initially loose, dry powder fill. These penetrate the interspaces between the individual particles 330a and join the particles 330a at their respective points of contact with the at least partially, advantageously completely, consolidated particles 330b.

The embodiments described with reference to FIGS. 3A and 3B may be combinable among one another. This means that the loose particles, explained by way of example in FIG. 3A, below the cap layer 340a may be (partially) consolidated. Also, a cap layer 340a may be arranged on the grating structure 320b shown in FIG. 3B.

All embodiments described herein comprise a substrate with a grating structure. A planar substrate made from a material with low X-ray absorption may serve as the base material. For creating the grating structure, the substrate may, for example, be provided with suitable, periodically arranged, cavities (e.g., 112, 212), which are filled with the loose, dry powder with high X-ray absorption (see FIG. 2A).

Suitable materials for substrates are, for example, silicon, glass, sapphire, ceramics, or polymers. Suitable powders are, for example, tungsten, bismuth or gold. The periodicity of the grating portions is, e.g., at most 50 μm. Optionally, the aspect ratio of the cavities is at least 9, advantageously at least 5.

According to the invention, the loose powder (e.g., 112, 212, 330a) is introduced into the cavities (e.g., 112, 212) in a dry state (see FIG. 2B). Subsequently, the loose powder fill may optionally be mechanically enclosed in the cavities by a suitable cap layer (e.g. 304a) on top of the powder (see FIG. 3A), and/or be mechanically (partially) consolidated by a suitable method (see FIG. 3B).

Suitable cap layers include, e.g., (polymer) films and/or polymers such as, e.g., curable epoxy resins, as well as organic or inorganic substances deposited from the gaseous phase (e.g., CVD). For mechanically consolidating a partial or complete volume of the loose powder fill, it is furthermore possible to optionally use liquid polymers or organic or inorganic substances deposited from the gaseous phase (e.g. ALD), which may penetrate the interspaces between the particles and mechanically join the particles at their points of contact.

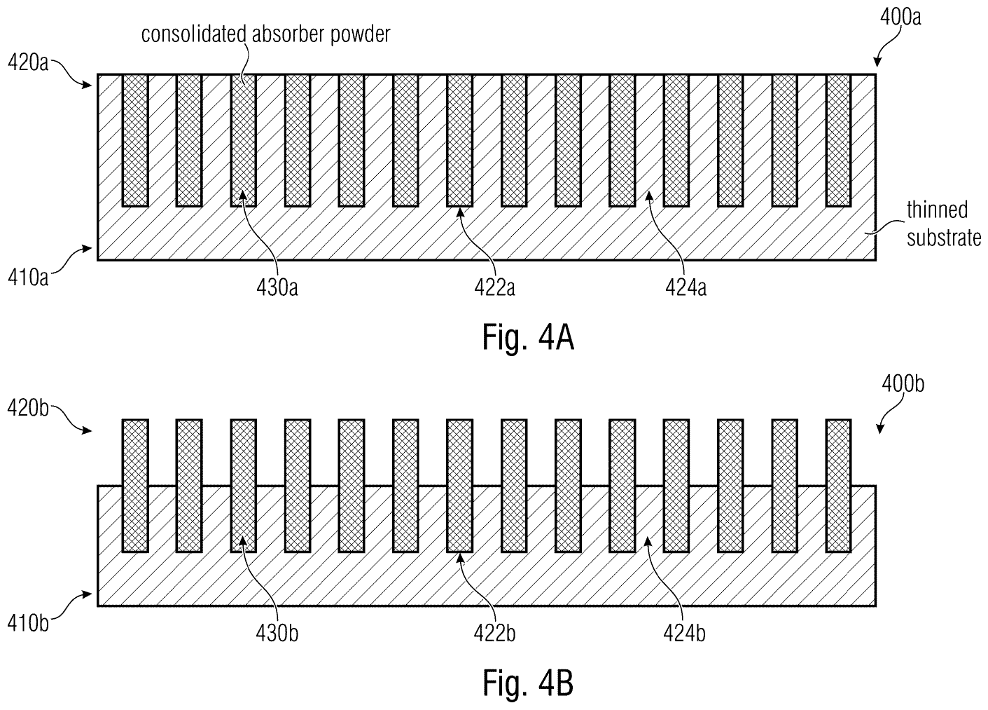

In the following, reference is made to FIGS. 4A and 4B, in which schematic views of a transmission grating 400a are shown, which comprise a substrate 410a that is backthinned on the rear side. In this embodiment, the substrate ridges located between the cavities may optionally be removed completely or partially.

FIG. 4A shows a transmission grating 400a with a thinned substrate 410a and with a grating structure 420a with first and second grating portions 422a, 424a. The first grating portions 422a are configured in the form of a plurality of particles 430a as it was described previously with reference to FIG. 3B. In other words, FIG. 4A shows a transmission grating 400a after backthinning or partial removal of the remaining rear-side substrate.

FIG. 4B shows the transmission grating 400b after the execution of a further inventive method step. In this process, the ridges made of substrate material and present between the (partially) consolidated particles, i.e., the second grating portions 424b, may be partially removed. The ridges of substrate material may be removed completely or partially. Moreover, the ridges of substrate material may be removed both from one and from both sides of the transmission grating.

In other words, FIGS. 4A and 4B show conceivable embodiments in which, after consolidation of the loose, dry powder, the remaining substrate on the rear side is first thinned or partially removed (FIG. 4A), and subsequently, the ridges therebetween are optionally completely or partially removed from one or both sides, e.g., by means of a suitable etching process (see FIG. 4B). Backthinning of the substrate is optional, although it does facilitate removing the ridges from the rear side.

By means of the embodiment shown in FIG. 4B, the contrast between the X-ray absorbing and the less X-ray absorbing lines of the grating can be increased. Moreover, the (partial) removal of the substrate ridges allows for mechanically bending the grating, e.g., to a defined radius. The interspaces resulting from the removal of the substrate material may optionally be filled with a suitable grouting material with low X-ray absorption (e.g. epoxy resin, PDMS, or other polymers), e.g., for increasing the mechanical stability.

A specific solution path according to embodiments for the manufacture of X-ray transmission gratings may, for example, include that, first, cavities with a desired grating period are created in a substrate, e.g., by means of a suitable high-rate etching process. In a further step, an X-ray absorber powder (as an example for a loose powder), such as, e.g., tungsten or bismuth powder, may be introduced into the cavities in a dry state. This may take place, e.g., by the dry powder, e.g., together with rubber balls, being dosed onto the substrate surface in a special apparatus, wherein the particles may be transported into the cavities and consolidated, optionally by superimposing a low-frequency vibration with ultrasound.

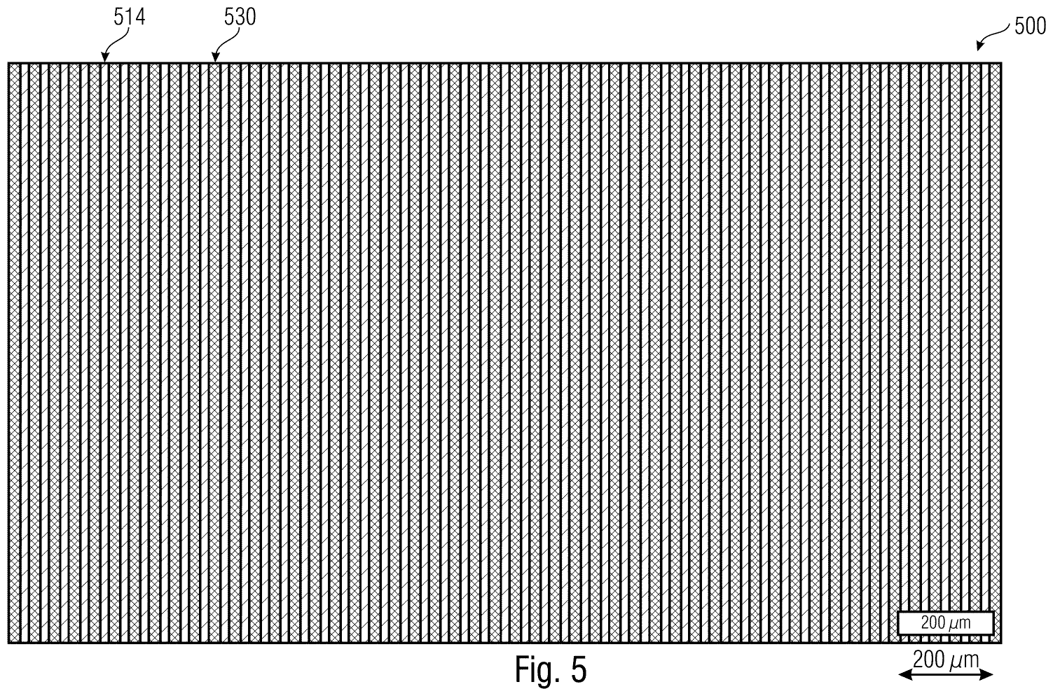

FIG. 5 shows a transmission grating 500 manufactured by means of the inventive method described herein. Here, the transmission grating 500 is filled, by way of example, with tungsten particles 530. The few tungsten particles (small dots) remaining on the silicon ridges 514 do not disturb the function of the transmission grating 500. Larger accumulations of tungsten particles 530, however, may be disturbing. In order to avoid such large accumulations, it is possible, as explained above, to use, e.g., a sacrificial layer in the manufacture of the transmission grating, which sacrificial layer may be applied and structured before creating the cavities, so that the surfaces of the substrate, including the substrate ridges 514 are completely or partially covered by the sacrificial layer before the particles 530 are introduced. After creating the absorbing grating lines in the substrate, the sacrificial layer may be removed selectively to all other materials present by means of a suitable etching process. In this process, remaining undesired particle accumulations may also be removed accordingly. Alternatively or additionally, the surface of the transmission grating may be smoothed and/or polished after the application of a cap layer, in order to remove absorbing particles 530 outside the X-ray absorbing grating lines from the substrate surface.

In an optional further method step, the surface of the substrate may be freed of excess powder, e.g., by means of a doctor knives. As mentioned above, the loose powder may optionally be completely or partially consolidated by means of a coating process. This may take place by applying an ALD process, e.g., with Al₂O₃, whereby the previously loose, dry powder can be consolidated to form solid porous microstructures. Moreover, in principle, all mechanically stable layers that can be deposited by means of atomic layer deposition (ALD), such as metals, metal oxides and nitrides, as well as polymers, and combinations thereof are suitable. In other words, embodiments may include any such materials as a coating material.

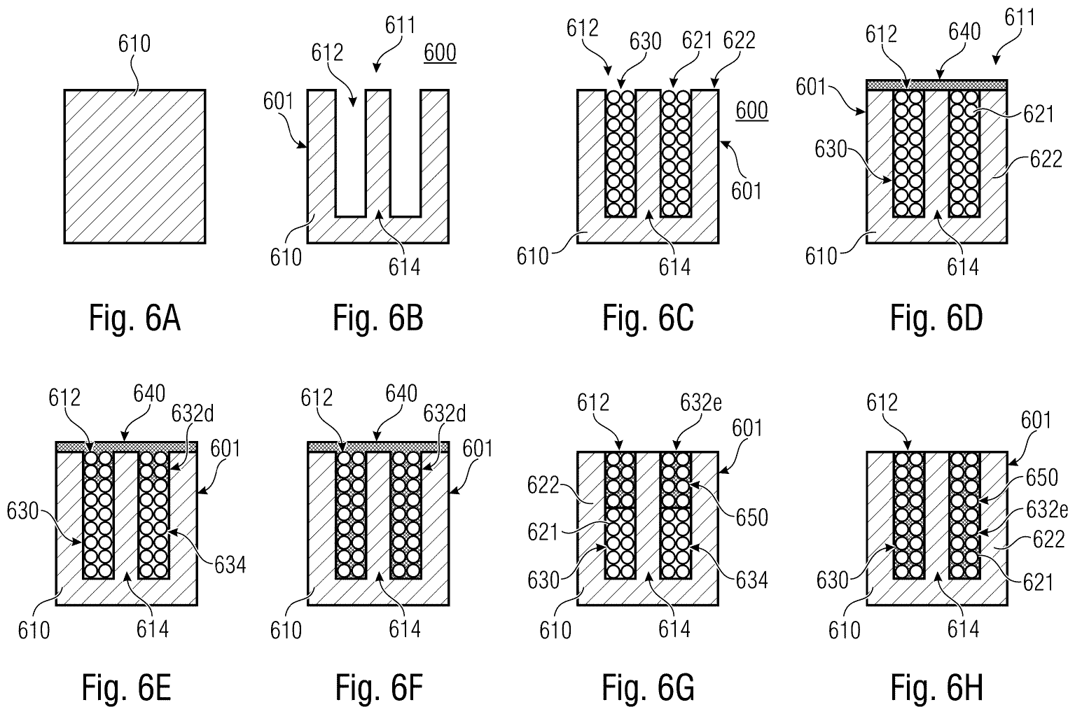

In the following, FIGS. 6A-6H each show schematic views of individual method steps for manufacturing invention transmission gratings including associated intermediate products.

FIG. 6A shows a substrate 610 which may serve as a base product for an inventive manufacturing method. The substrate 610 may comprise silicon, glass, sapphire, ceramic, and/or polymers or be composed of such a material.

FIG. 6B shows a process step for creating a grating structure 601 in or on the substrate 610. In this non-limiting example, the grating structure 601 may be created by a plurality of cavities 612 being structured into a first main side 611 of the substrate 610. This may be executed by means of etching, e.g., by applying a high-rate etching process (e.g., ionic deep reactive etching). Alternatively or additionally, lithographic processes, e.g., using photoresists, may be used. The cavities 512 may comprise an aspect ratio, regarding width/depth, of at least 1:9 or at least 1:5.

Between each of the cavities 612, ridges 614 may remain. If the cavities 612 are structured directly into the substrate 610 as described above, the ridges 614 may accordingly be formed of substrate material which remained standing during the creation of the cavities 612. In alternative embodiments, these remaining substrate ridges 614 may be removed completely or partially, and subsequently be optionally filled, completely or partially, with a filler. In this case, ridges 614 arranged between the cavities 612 would contain this filler completely or partially.

The cavities 612 are created such that they are periodically arranged in the substrate material. This means that a plurality of cavities 612 may be created, which are all arranged at the same distance from one another. The grating structure 601 may comprise, e.g., a grating period of less than 50 μm. A thickness of the cavities 612 may be at least 100 μm or more, whereby a particularly good absorption of X-radiation can be achieved. The thickness is measured in the direction of arrival of the X-radiation to be deterred.

FIG. 6C shows a further process step, wherein the cavities 612 may be filled with particles 630 in the form of loose, dry powder. The cavities 612 may, in this process, be filled completely or partially. For this purpose, the dry, loose particle powder 630 may be poured on a surface of substrate 610 facing the openings of the cavities 612, or on the first main side 611 of the substrate. Subsequently, vibrations of a first frequency range (e.g., 25 Hz to 150 Hz) may be superimposed with vibrations of a second frequency range (e.g., 10 kHz to 100 kHz), in order to convey the dry, loose particles 630 into the cavities 612 and to optionally consolidate them.

Subsequently, excess loose particles 630, which may still be present outside the cavities 612, may be removed, so that the filled cavities 612 are at least approximately flush with the substrate surface.

Optionally, spherical elements (e.g. rubber balls) may be applied to the substrate surface together with the dry, loose particle powder 630, wherein the spherical elements may comprise a diameter that is at least three times larger than a maximum width or a maximum diameter of a respective cavity 612. By means of the spherical elements, agglomerates of the loose, dry particles 630, which have possibly formed, can be broken up. This may be performed, particularly, by means of vibrations as explained above, so that the spherical elements move and thereby eliminate inhomogeneities of the loose, dry powder 630 in the cavities 612. Subsequently, the spherical elements are removed again. Alternatively or additionally, the excess loose particles 630 present on the substrate surface may be removed by means of doctor knives.

Generally, first grating portions comprising a particle 630 distribution largely free of gas bubbles and homogenous may be formed by using superimposed vibrations and/or spherical elements, but also without applying such optional steps.

In this case, the particles 630 may, as explained above, comprise at least one of the materials tungsten, bismuth, and/or gold, or be composed of one of these materials, in this manufacturing step in the form of a powder.

With reference to FIG. 6C, it may thus far be noted that the transmission grating 600 comprises a substrate 610 and a grating structure 601. The grating structure 601, in turn, comprises a plurality of alternating first and second grating portions 621, 622. The first grating portions 621 comprise a higher absorption of X-radiation than the second grating portions 622. The first grating portions 621 may be configured in the form of cavities 612 filled with particles 630. The second grating portions 624 may be configured in the form of ridges 614 arranged between the cavities 612. The ridges 614 may comprise substrate material and/or a filler.

FIGS. 6A-6H show, purely by way of example, two cavities 612 and three ridges 614. The inventive transmission grating 600 may, however, also comprise significantly more cavities 612 and ridges 614, or significantly more alternating first and second grating portions 621, 622. The first grating portions 621, which, up to the method step shown in FIG. 6C, are formed by a dry particle powder 630, may be coated and consolidated in optional further method steps, and/or may be enclosed in the cavities 612 by means of a cover layer. This is to be explained in the following with reference to FIGS. 6D and 6E.

FIGS. 6D and 6F show optional further method steps by means of which a cap layer 640 may be applied to the first main side 611, or to the grating structure 601 including the first and second grating portions 621, 622. The cap layer 640 may be applied, for example, in the form of a polymer film, a curable polymer layer, or in the form of organic or inorganic substances deposited from the gaseous phase (e.g., by means of CVD or ALD). The particles 630 may be enclosed in the cavities 612 by means of the cap layer 640.

As shown in FIG. 6D, the cap layer 640 may span the grating structure 601 completely. The cap layer 640 may, in this case, be on top of the first and second grating portions 621, 622. This would be the case, for example, with polymer films.

However, if the cover layer 640 is applied by means of a coating method, the coating material used, e.g., a liquid polymer, may partially penetrate the cavities 612, as this is shown by way of example in FIG. 6E. It would also be conceivable that the coating material of the cap layer 640 penetrates the cavities 612 completely, as it is represented by way of example in FIG. 6F. The coating material may intersperse the particles 630 present in the cavities 612 and, in doing so, act as a coating for the particles 630.

Thus, the particle powder 630 present in the cavities 612 may be partially consolidated or completely consolidated by means of the cap layer 640, or by means of the coating material used. In case of a partial consolidation (FIG. 6E), the particles 630 may form porous bodies 632d arranged in the region of the first main side 611 of the substrate in the cavities 612. Loose particles 634 below that remained uncoated may be enclosed in the cavities 612. As a result, a transmission grating 601 with a cap layer 640 covering the first and second grating portions 621, 622 is created, wherein the first grating portions 621 comprise partially consolidated particle powder 630.

In the case of a complete penetration (FIG. 6F) of the particle powder 630 with coating material, the entire particle powder 630 may be consolidated, so that largely all particles are consolidated to form solid porous bodies 632d by means of the coating. As a result, a transmission grating 601 with a cap layer 640 covering the first and second grating portions 621, 622 is created, wherein the first grating portions 621 comprise completely consolidated particle powder 630, or solid porous structural bodies 632d.

Alternatively, the dry particle powder 630, as it is shown by way of example in FIGS. 6G and 6H, may also be partially consolidated or completely consolidated by means of a coating 650, regardless of a cap layer 640. For this purpose, for example, a coating method may be used, wherein the particle powder 630 may be consolidated to form solid porous bodies 632e by means of the coating material used. For mechanically joining or consolidating the initially loose, dry powder fill 630, for example, liquid polymers or organic or inorganic substances deposited from the gaseous phase (e.g. by means of ALD/CVD) may be used. These penetrate the interspaced between the individual particles and join these particles at their respective points of contact.

In summary, the first grating portions 621 of the grating structure 601 may therefore be formed by particles present in the cavities 612, which particles are present either only in the form of a loose, dry powder 630, and may optionally be enclosed in the cavities 612 by a cap layer 640 in order to secure the particles against falling out. Alternatively or additionally, the particle powder 640 may be partially consolidated, wherein a mixture of solid porous bodies 632d, 632e and unconsolidated, i.e., loose, dry powder 630, is present, wherein this mixture forms the first grating portion 621. Here, as well, a cap layer 640 may optionally be present. Alternatively, the particle powder 630 may be completely consolidated, wherein solid porous bodies 632d, 632e are present, which, in turn, form the first grating portions 621. Here, as well, a cap layer 640 may optionally be present.

In the above-described method steps, the first grating portions 621 were created by cavities 612 being structured into the substrate 610, which cavities 612 are subsequently filled with dry particle powder 630, wherein the particle powder 630 was (partially) consolidated. The second grating portions 622 were present in the form of ridges 614 of substrate material which remained during the structuring of the substrate. The inventive method may comprise optional further method steps. For example, the ridges 614 made of substrate material may be removed completely or partially. The removed regions may then be filled, also completely or partially, with a filler. In this case, the ridges 614 are created from filler.

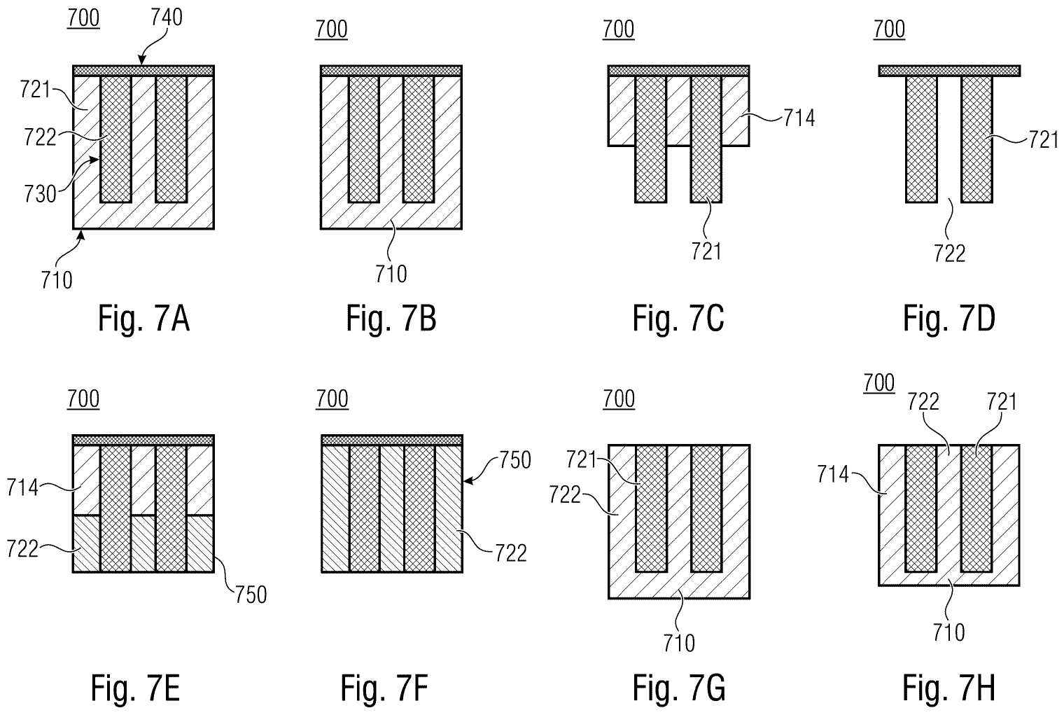

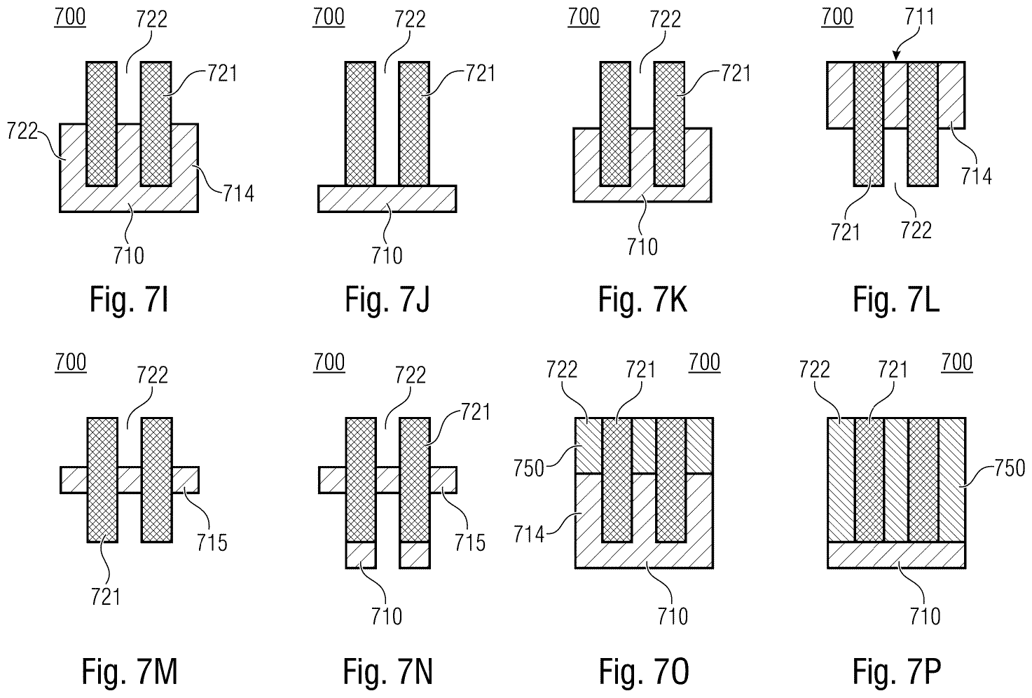

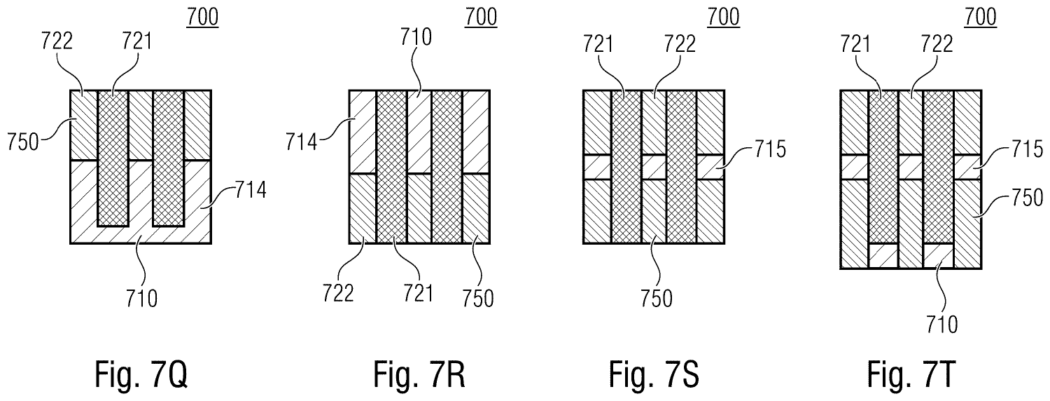

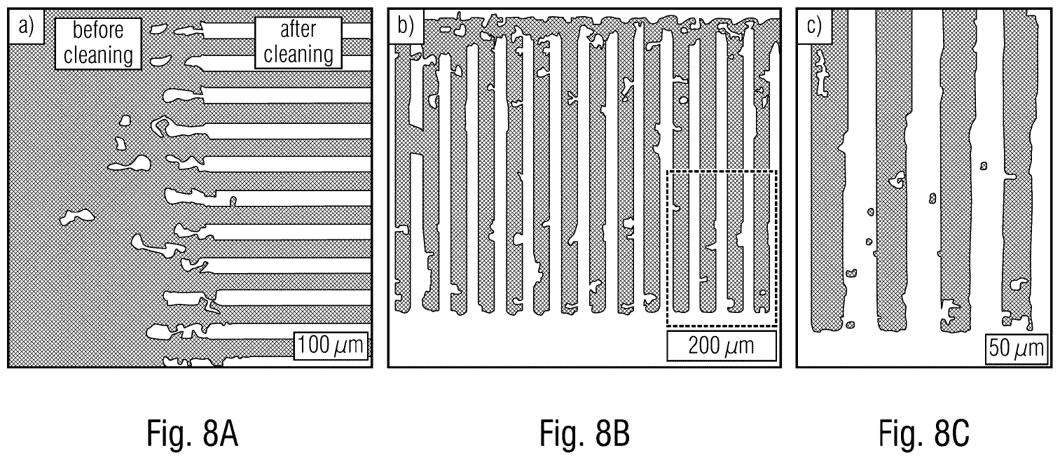

FIGS. 7A-7T show different possibilities of how a transmission grating 700 with first and second grating portions 721, 722 can be created by means of the inventive method. In all FIGS. 7A-7T, transmission gratings are denoted by 700, first grating portions by 721, second grating portions by 722, substrates by 710, ridges by 714, particles by 730, cap layers by 740, and fillers, or grouting materials, by 750. Compared to FIGS. 6A-6H, the particles 730 are represented here in a simplified manner. However, the particles 730 may also be present in the form of loose, dry powders or in the form of solid porous bodies, which may be created from particles partially consolidated or completely consolidated by means of a coating.

FIG. 7A first shows an embodiment as it was described before with reference to FIGS. 6D-6F. Optionally, the substrate 710 may be thinned from a rear side (FIG. 7B). Furthermore, the ridges 714 made of substrate material and arranged between the first grating portions 721 may be at least partially removed (FIG. 7C). Alternatively, the ridges 714 may also be removed completely, see FIG. 7D. The removal of the ridges 714 may take place from a rear side, as is shown by way of example in the figures. Alternatively or additionally, the ridges 714 may, however, also be completely or partially removed from a front side of the substrate 710. In these cases, the second grating portions 722 may be formed in the form of air gaps between the first grating portions 721 (e.g. (partially consolidated) particles).

As shown in FIGS. 7E and 7F, the removed substrate regions may optionally be filled again, completely or partially, by means of a filler 750, e.g., a grouting material. In this case, the second grating portions 722 may be formed in the form of ridges 714 made of filling material and/or substrate material between the first grating portions 721 (e.g. (partially consolidated) particles).

FIG. 7G shows an embodiment without a covering layer. Here, as well, the substrate 710 may optionally be thinned from a rear side (FIG. 7H). Furthermore, the ridges 714 made of substrate material may be removed completely (FIG. 7J) or partially (FIG. 7I) from one or both substrate sides. In both cases, the substrate 710 may again be thinned from the rear side (FIG. 7K). Optionally, the removal of the ridges 714 made of substrate material may also be performed from the rear side of the substrate 710, i.e., opposite to the first main side 711 (FIG. 7L). Furthermore, the removal of the ridges 714 made of substrate material may alternatively also be performed starting from both sides of the substrate 710, wherein a portion 714 of substrate material may remain due to an incomplete removal (FIGS. 7M and 7N).

In these cases, as well, removed substrate material may again be filled up by means of a filler 750 (FIGS. 7O-7T). Depending on whether the regions of removed substrate material are filled completely or partially filled with the filler 750, the second grating portions 722 may comprise the filler 750 and/or substrate material. In all cases in which filler 750 is used, this filler 750 may comprise a lower absorption of X-radiation than the particles 730.

As can be seen in FIGS. 7A-7T, the first grating portions 721 formed by means of the particles 730 may also be arranged only partially in a cavity in the substrate 710. In this regard, the cavities may be formed by means of substrate material, or also by means of the filler 750, wherein the first grating portions 721 may therefore be arranged partially in the cavities, formed by means of substrate material, and partially in cavities, formed by means of filler 750.

As can also be seen in FIGS. 7A-7T, the second grating portions 721 may be formed by means of substrate material, by means of substrate material and filler 750, or only by means of filler 750, so that they are arranged alternatingly with the first grating portions 721 for forming the transmission grating 700.

At this point, it should be noted again that embodiments generally provide a particularly cost-effective manufacture compared to existing methods. Furthermore, a particularly homogeneous filling, particularly by avoiding gas bubble inclusions, may be achieved. Moreover, a high variety of materials can be used, particularly tungsten as a particularly advantageous absorber material.

As explained in detail above, embodiments allow for a dry filling of dry, loose particles into cavities, so that inclusions of gas bubbles such as, e.g., during wet filling, can be avoided. Thus, particularly homogenous structures may be created.

In addition to the high flexibility in the selection of materials, embodiments further allow realizing very short processing times. Additionally, high aspect ratios (e.g., of the cavities and thus of the first grating portions) can be made possible. It is particularly possible to use absorber materials regardless, or essentially regardless, of their melting point (e.g. regarding a melting point of the substrate material). The inventive use of coating processes allows, in particular, a “gentle” processing, regarding the thermal stress (e.g., by means of conducting the coating at moderate temperatures), of the transmission grating, so that thermally sensitive materials may also be used.

Moreover, electroplating may be refrained from according to embodiments. Thus, embodiments may, as explained above, particularly comprise tungsten particles.

The inventive transmission gratings may, for example, be used in dark field radiography (e.g., nondestructive analysis, clinical application), and/or in dark field computer tomography (e.g., nondestructive analysis, clinical application.

All materials, environmental influences, electrical properties, and optical properties listed herein, are to be considered exemplary and not exhaustive.

Although some aspects have been described in the context of an apparatus, it is clear that these aspects also represent a description of the corresponding method, where a block or device of an apparatus is also to be understood as a corresponding method step or a feature of a method step. Analogously, aspects described in the context of or as a method step also represent a description of a corresponding block or item or feature of a corresponding apparatus.

The above described embodiments are merely illustrative for the principles of the innovative concept described herein. It is understood that modifications and variations of the arrangements and the details described herein will be apparent to others skilled in the art. It is the intent, therefore, that the concept described herein be limited only by the scope of the impending patent claims and not by the specific details presented by way of description and explanation of the embodiments herein.

In the following, embodiments according to the present invention are summarized: A first embodiment includes a method for manufacturing a micostructured transmission grating (100, 300a,b, 400a,b) for X-radiation, the method comprising: providing a substrate (110, 210, 310a,b, 410a,b, 610, 710) and creating a grating structure (120, 320a,b, 420a,b) by means of structuring a plurality of periodically arranged cavities (112, 212, 612) in a first main side of the substrate, wherein individual ridges (114, 514, 614) of substrate material remain between each of the cavities; filling the cavities with particles (130, 230, 330a,b, 430a,b, 530, 630, 730) in the form of loose, dry powder; wherein the substrate comprises a lower absorption of X-radiation than the particles located in the cavities.

According to a second embodiment, the method according to the first embodiment further comprises: at least partial consolidation of the particles located in within the cavities (112, 212, 612) using a coating process in order to provide at least a part of the particles (130, 230, 330a,b, 430a,b, 530, 630, 730) in the form of a plurality of consolidated porous bodies (632d,e) with higher X-radiation absorption compared to the substrate (110, 210, 310a,b, 410a,b, 610, 710).

According to a third embodiment, the particles located in the individual cavities (112, 212, 612) are each completely consolidated by means of the coating process to form porous bodies (632d,e) in the method according to the second embodiment.

According to a fourth embodiment, the coating process is performed, in the method according to the second or the third embodiment, using a liquid polymer; and/or the coating process comprises depositing organic and inorganic substances from a gaseous phase, e.g., by means of a chemical vapor deposition, or, e.g., by means of an atomic layer deposition.

According to a fifth embodiment, the method according to one of the preceding embodiments further comprises: applying a cap layer (340a, 640, 740) to the first main side of the substrate in order to enclose the particles (130, 230, 330a,b, 430a,b, 530, 630, 730) located in the cavities (112, 212, 612) therein.

According to a sixth embodiment, applying the cap layer (340a, 640, 740) comprises, according to the fifth embodiment, at least one of the following steps:
applying a mechanically stable film, e.g., a polymer film or a metal film,
applying a polymer layer, and/or
applying organic or inorganic substances deposited from the gaseous phase, e.g., by means of chemical and/or physical vapor deposition or, e.g., by means of atomic layer deposition.

According to a seventh embodiment, the method according to one of the preceding embodiments further comprises: backthinning of a second main side of the substrate (110, 210, 310a,b, 410a,b, 610, 710) opposite the first main side of the substrate.

According to an eighth embodiment, the method according to one of the preceding embodiments further comprises: at least partially removing one or multiple ones of the remaining ridges (114, 514, 614) of substrate material.

According to a ninth embodiment, according to the eighth embodiment, the ridges (114, 514, 614) are at least partially removed from the first main side, and/or the ridges are at least partially removed from a second main side of the substrate (110, 210, 310a,b, 410a,b, 610, 710) opposite the first main side.

According to a tenth embodiment, the method according to the eighth or ninth embodiment further comprises: at least partially filling the regions, in which the ridges (114, 514, 614), or parts of the ridges, of substrate material are removed, with a filler (750); wherein the filler comprises a lower absorption of X-radiation than the particles (130, 230, 330a,b, 430a,b, 530, 630, 730).

According to an eleventh embodiment, the method according to one of the preceding embodiments further comprises: applying a sacrificial layer to the first main side of the substrate (110, 210, 310a,b, 410a,b, 610, 710) before creating the grating structure (120, 320a,b, 420a,b); wherein the structuring of the plurality of periodically arranged cavities (112, 212, 612) in the first main side of the substrate (110, 210, 310a,b, 410a,b, 610, 710) comprises structuring the sacrificial layer, so that the individual ridges (114, 514, 614) respectively remaining between the cavities (112, 212, 612) remain covered by the sacrificial layer; and wherein the method further comprises removing the sacrificial layer after filling the cavities (112, 212, 612) with the particles (130, 230, 330a,b, 430a,b, 530, 630, 730).

A twelfth embodiment includes a microstructured transmission grating (100, 300a,b, 400a,b) for X-radiation, the transmission grating comprising: a substrate (110, 210, 310a,b, 410a,b, 610, 710) with a grating structure (120, 320a,b, 420a,b), the grating structure comprising multiple alternating first and second grating portions; wherein the first grating portions (122, 322a,b, 422a,b) comprise a plurality of particles (130, 230, 330a,b, 430a,b, 530, 630, 730) present in the form of loose, dry powder and/or in the form of particles consolidated by means of a coating; and wherein the first grating portions comprise a higher absorption of X-radiation than the second grating portions in order to thus form the microstructured transmission grating for the X-radiation.

According to a thirteenth embodiment, the substrate (110, 210, 310a,b, 410a,b, 610, 710) in the transmission grating according to the twelfth embodiment comprises a plurality of periodically arranged cavities (112, 212, 612); and the respective cavities form the first grating portions (122, 322a,b, 422a,b).

According to a fourteenth embodiment, the respective cavity (112, 212, 612) in the transmission grating according to the thirteenth embodiment comprises an aspect ratio, regarding width to depth, of at least 1:9 or at least 1:5.

According to a fifteenth embodiment, the particles (130, 230, 330a,b, 430a,b, 530, 630, 730) in the transmission grating according to the thirteenth or fourteenth embodiment are present both in the form of loose, dry powder and/or in the form of particles consolidated by means of a coating to form porous bodies (632d,e); and the loose, dry powder is enclosed, in each case, between the consolidated particles and the substrate (110, 210, 310a,b, 410a,b, 610, 710) in the cavities (112, 212, 612).

According to a sixteenth embodiment, the particles (130, 230, 330a,b, 430a,b, 530, 630, 730) in the transmission grating according to the twelfth, thirteenth, or fourteenth embodiment are present in the form of particles consolidated by means of a coating to form porous bodies (632d,e), wherein the porous bodies each form the first grating portions (122, 322a,b, 422a,b).

According to a seventeenth embodiment, the first grating portions (122, 322a,b, 422a,b) in the transmission grating according to the fifteenth or sixteenth embodiment comprise a particle (130, 230, 330a,b, 430a,b, 530, 630, 730) distribution free of imperfections, wherein imperfections are voids which are several times larger than an average pore size of the porous bodies (632d,e).

According to an eighteenth embodiment, the second grating portions in the transmission grating according to one of the twelfth to seventeenth embodiments comprise substrate material and/or a material different from the substrate (110, 210, 310a,b, 410a,b, 610, 710), wherein the material different from the substrate (110, 210, 310a,b, 410a,b, 610, 710) is configured in the form of a filler (750) with a lower X-ray absorption compared to the first grating portions (122, 322a,b, 422a,b).

According to a nineteenth embodiment, the transmission grating according to one of the twelfth to eighteenth embodiments further comprises: a cap layer (340a, 640, 740) arranged on the grating structure (120, 320a,b, 420a,b) for enclosing the particles (130, 230, 330a,b, 430a,b, 530, 630, 730) in the first grating portions (122, 322a,b, 422a,b).

According to a twentieth embodiment, the grating period of the grating structure (120, 320a,b, 420a,b) is less than 50 μm in the transmission grating according to one of the twelfth to nineteenth embodiments.

According to a twenty-first embodiment, the first grating portions (122, 322a,b, 422a,b) in the transmission grating according to one of the twelfth to twentieth embodiments each comprise a thickness of at least 100 μm to be measured in a direction of arrival of the X-radiation.

According to a twenty-second embodiment, the particles (130, 230, 330a,b, 430a,b, 530, 630, 730) in the transmission grating according to one of the twelfth to twenty-first embodiments comprise tungsten or are composed of tungsten.

According to a twenty-third embodiment, the substrate (110, 210, 310a,b, 410a,b, 610, 710) in the transmission grating according to one of the twelfth to twenty-second embodiments comprises at least one of the following materials or is composed of at least one of these materials: silicon, glass, sapphire, ceramics, or polymers.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] C. Kostmann, T. Lisec, M. Bodduluri, and O. Andersen, “Automated Filling of Dry Micron-Sized Particles into Micro Mold Pattern within Planar Substrates for the Fabrication of Powder-Based 3D Microstructures,” Micromachines, vol. 12, no. 10, p. 1176, 2021, doi: 10.3390/mi12101176.
[2] T. Lisec, O. Behrmann, and B. Gojdka, “PowderMEMS-A Generic Microfabrication Technology for Integrated Three-Dimensional Functional Microstructures,” Micromachines, vol. 13, no. 3, p. 398, 2022, doi: 10.3390/mi 13030398.

1. Method for manufacturing a micostructured transmission grating for X-radiation, the method comprising:
providing a substrate and creating a grating structure by means of structuring a plurality of periodically arranged cavities in a first main side of the substrate, wherein individual ridges of substrate material remain between each of the cavities;
filling the cavities with particles in the form of loose, dry powder;
wherein the substrate comprises a lower absorption of X-radiation than the particles located in the cavities.

2. Method according to claim 1, further comprising:
at least partial consolidation of the particles located in within the cavities using a coating process in order to provide at least a part of the particles in the form of a plurality of consolidated porous bodies with higher X-radiation absorption compared to the substrate.

3. Method according to claim 2,
wherein the particles located in the individual cavities are each completely consolidated by means of the coating process to form porous bodies.

4. Method according to claim 2,
wherein the coating process is performed using a liquid polymer; and/or
wherein the coating process comprises depositing organic and inorganic substances from a gaseous phase, e.g., by means of a chemical vapor deposition, or, e.g., by means of an atomic layer deposition.

5. Method according to claim 1, further comprising:
applying a cap layer to the first main side of the substrate in order to enclose the particles located in the cavities therein.

6. Method according to claim 1, further comprising:
backthinning of a second main side of the substrate opposite the first main side of the substrate.

7. Method according to claim 1, further comprising:
at least partially removing one or multiple ones of the remaining ridges of substrate material.

8. Method according to claim 7,
wherein the ridges are at least partially removed from the first main side, and/or
wherein the ridges are at least partially removed from a second main side of the substrate opposite the first main side.

9. Method according to claim 7, further comprising:
at least partially filling the regions, in which the ridges, or parts of the ridges, of substrate material are removed, with a filler;
wherein the filler comprises a lower absorption of X-radiation than the particles.

10. Method according to claim 1, further comprising:
applying a sacrificial layer to the first main side of the substrate before creating the grating structure;
wherein the structuring of the plurality of periodically arranged cavities in the first main side of the substrate comprises structuring the sacrificial layer, so that the individual ridges respectively remaining between the cavities remain covered by the sacrificial layer; and
wherein the method further comprises removing the sacrificial layer after filling the cavities with the particles.

11. Microstructured transmission grating for X-radiation, the transmission grating comprising:
a substrate with a grating structure, the grating structure comprising multiple alternating first and second grating portions;
wherein the first grating portions comprise a plurality of particles present in the form of loose, dry powder and/or in the form of particles consolidated by means of a coating; and
wherein the first grating portions comprise a higher absorption of X-radiation than the second grating portions in order to thus form the microstructured transmission grating for the X-radiation.

12. Transmission grating according to claim 11,
wherein the substrate comprises a plurality of periodically arranged cavities; and
wherein the respective cavities form the first grating portions.

13. Transmission grating according to claim 12,
wherein the respective cavity comprises an aspect ratio, regarding width to depth, of at least 1:9 or at least 1:5.

14. Transmission grating according to claim 12,
wherein the particles are present both in the form of loose, dry powder and/or in the form of particles consolidated by means of a coating to form porous bodies; and
wherein the loose, dry powder is enclosed, in each case, between the consolidated particles and the substrate in the cavities.

15. Transmission grating according to claim 11,
wherein the particles are present in the form of particles consolidated by means of a coating to form porous bodies, wherein the porous bodies each form the first grating portions.

16. Transmission grating according to claim 14,
wherein the first grating portions comprise a particle distribution free of imperfections, wherein imperfections are voids which are several times larger than an average pore size of the porous bodies.

17. Transmission grating according to claim 11,
wherein the second grating portions comprise substrate material and/or a material different from the substrate, wherein the material different from the substrate is configured in the form of a filler with a lower X-ray absorption compared to the first grating portions.

18. Transmission grating according to claim 11, further comprising:
a cap layer arranged on the grating structure for enclosing the particles in the first grating portions.

19. Transmission grating according to claim 11,
wherein the grating period of the grating structure is less than 50 μm; and/or
wherein the first grating portions each comprise a thickness of at least 100 μm to be measured in a direction of arrival of the X-radiation.

20. Transmission grating according to claim 11,
wherein the particles comprise tungsten or are composed of tungsten.
